(19) United States
(12) Patent Application Publication
(10) Pub. No.: US 2004/0140691 A1
(43) Pub. Date: Jul. 22, 2004

(54) Shock absorbing material

(76) Inventor: Toshiyuki Horimatsu, Yokohama- (JP)

Correspondence Address: SUGHRUE MION, PLLC, 2100 PENNSYLVANIA AVENUE, N.W., SUITE 800, WASHINGTON, DC, 20037, US

(21) Appl. No.: 10/476,842

(22) PCT Filed: Oct. 28, 2002
(86) PCT No.: PCT/JP02/11129

(30) Foreign Application Priority Data
Oct. 29, 2001 (JP) 2001-331038

(51) Int. Cl. B60J 7/00

(52) U.S. Cl. 296/187.05

(57) ABSTRACT

An impact absorbing member is provided which has significantly excellent impact energy absorbing efficiency and is suitable as a head protecting member capable of absorbing impact energy applied to a head of an occupant in a vehicle cabin during a vehicle collision or the like and capable of reducing the value of head injury criteria. The impact absorbing member comprises a body 11 made of a rigid polyurethane foam and a surface member 12 which has a rigidity higher than that of the body 11 and is disposed on the impact receiving surface of the body 11. The surface member 12 has a thickness of 0.5-5 mm and is made of synthetic resin, metal, alloy, glass, or ceramics. The rigid polyurethane foam has a thickness of 10-80 mm, a compressive stress at 50% relative deformation of 0.25-2 MPa, and a density of 40-200 kg/m³.

### CROSS REFERENCE TO RELATED APPLICATION

This is a continuation application of PCT/JP02/11129 filed on Oct. 28, 2002.

### FIELD OF THE INVENTION

The present invention relates to an impact absorbing member.

### BACKGROUND OF THE INVENTION

To protect a head or other part of an occupant by absorbing impact produced when the head or other part of the occupant collides with interior trim such as a ceiling of a vehicle cabin in the event of vehicle collision, an impact absorbing member is provided.

Examples of conventional impact absorbing member include a rigid polyurethane foam, a polyolefin foam, a resin formed body having a rib on one surface thereof, and a pressed product made of steel or the like. An impact absorbing member made of rigid polyurethane foam has the following advantages: excellent impact absorbing characteristics; low temperature dependence of the impact energy absorbing characteristics; impact absorbing characteristics which is relatively stable against a variety of plunging angle of a free motion head dummy (FMH); easy adjustment of the impact absorbing characteristics; and good economical efficiency because of relatively low cost.

The ideal impact absorbing characteristics as impact absorbing member is as follows: its load reaches a certain value (certain acceleration) at an initial stage of the compression and, after that, keeps the certain value (certain acceleration), that is, has an F-S waveform (load-stroke waveform) in which the load (F) rises promptly relative to the stroke (S) and, after that, the load (F) keeps substantially constant with transition of the stroke (S).

The impact absorbing member made of rigid polyurethane foam exhibits the F-S waveform nearly equal to the ideal F-S waveform when impact is applied evenly to the whole surface thereof, such as when compressed between two flat plates.

The rigid polyurethane foam is a buckling (brittle) member. Therefore, as shown in FIGS. 2a, 2b, when a spherical body such as a free motion head dummy (FMH) 1 collides with and compress an impact absorbing member 2 made of rigid polyurethane foam, stress is locally concentrated on the impact absorbing member 2 and the FMH 1 dents into the impact absorbing member. In this case, the impact energy thereby absorbed is small. That is, as shown in FIG. 2b, when the conventional head protecting member 2 of rigid polyurethane foam is pressed by the FMH 1 at a small area as shown by broken lines 2A, only a portion including the area shown by the broken lines 2A and just around the area contributes to the impact energy absorption.

Increasing the degree of hardness of the entire rigid polyurethane foam increases the load in the initial stage of collision and also excessively increases the load in the later stage of compression.

### SUMMARY OF THE INVENTION

An impact absorbing member according to the present invention is an impact absorbing member comprising a body made of a rigid polyurethane foam and a surface member which has a rigidity higher than that of the body and is disposed on the impact receiving surface of the body.

### BRIEF DESCRIPTION OF THE DRAWINGS

FIGS. 1a and 1b are schematic plan views showing an impact absorbing member according to an embodiment of the present invention in a state that an FMH collides the impact absorbing member;

FIGS. 2a and 2b are schematic plan views showing an impact absorbing member according to a conventional example in a state that an FMH collides the impact absorbing member; and

FIG. 3 is a graph showing F-S waveforms of impact absorbing members of Example 1 and Comparative Example 1.

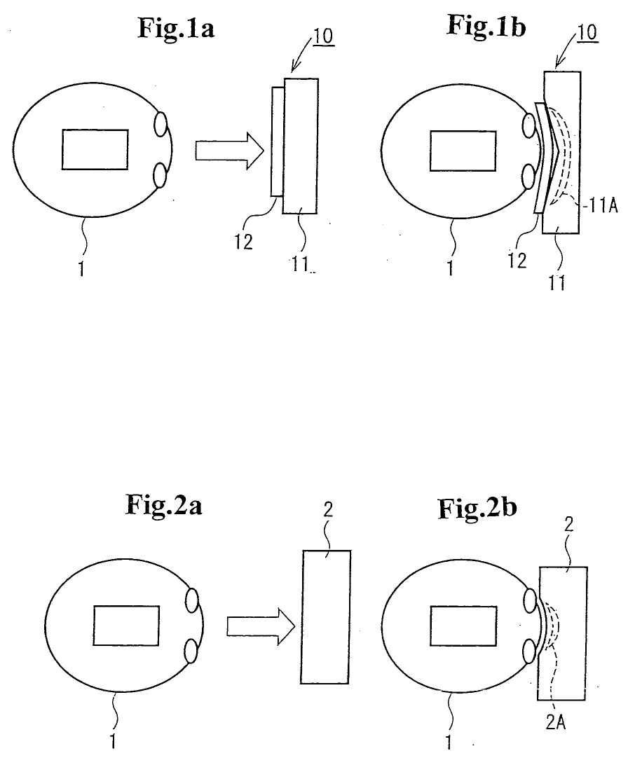

### DESCRIPTION OF THE PREFERRED EMBODIMENTS

FIG. 1a shows an impact absorbing member 10 according to an embodiment of the present invention. The impact absorbing member 10 comprises a body 11 made of a rigid polyurethane foam and a surface member 12 which has a rigidity higher than that of the body 11 and is disposed on one surface of the body 11. The load generated in the initial stage of collision with an FMH 1 is dispersed on a wider area by the surface member 12. Therefore, as shown in FIG. 1b, the compressive load in the initial stage acts on a wider area of the body 11.

That is, since the surface member 12 has higher rigidity, the body 11 is squashed to deform not only a collided portion where the FMH 1 collides but also a wider area (shown by broken lines 11A) around the collided portion. Accordingly, even with a short stroke, large impact energy can be absorbed. By properly selecting the rigidity and the area of the surface member, a desired load-stroke curve is imparted to the impact absorbing member.

The body 11 is preferably in a shape of a plate including a flat plate and a curved plate. The rigid polyurethane foam forming the body 11 preferably has a compressive stress at 50% relative deformation of about 0.25 MPa or more, particularly from about 0.25 MPa to 2 MPa, more particularly from about 0.25 MPa to 1.6 MPa. The rigid polyurethane foam preferably has a density of from 40 kg/m³ to 200 kg/m³, particularly from 40 kg/m³ to 140 kg/m³.

The surface member 12 has a rigidity higher than that of the rigid polyurethane foam of the body 11 and preferably has a flexural modulus from 2 MPa to 1500 MPa. The surface member 12 is preferably made of synthetic resin, metal, alloy, glass, ceramics, and the like. Examples of the synthetic resin include polypropylene, polyethylene and polyethylene terephthalate. Examples of the metal include iron, aluminum, and copper. Examples of the alloy include iron-based alloy, aluminum-based alloy, and copper-based alloy. The surface member may be made of paper material, such as corrugated cardboard, or wood. In this case, however, a large thickness is required.

When the impact absorbing member is a head protecting member, the body preferably has a thickness of 10-80 mm, particularly 10-40 mm, more particularly 20-30 mm. When the thickness of the body is less than 10 mm, enough stroke is not obtained so as not to exhibit enough impact energy absorbing efficiency. On the other hand, when the thickness of the body exceeds 80 mm, the impact absorbing member is bulky. Even the impact absorbing member comprising a body having a small thickness in a range from 10 mm to 25 mm can exhibit excellent impact energy absorbing efficiency.

The surface member is in a shape of a plate preferably having a thickness of about 0.5-5 mm. When the impact absorbing member comprises the surface member having a thickness of less than 0.5 mm, the impact absorbing property is insufficient even if the surface member is made of a high-rigid material such as ceramics. When the surface member has a thickness exceeding 5 mm, the rigidity of the impact absorbing member should be too large.

The surface member 12 and the body 11 may be united together. The surface member 12 may be united with the body 11 with adhesive or pressure-sensitive adhesive. The surface material 12 may be disposed in a mold for forming the body and the body may be formed and integrated with the surface member by insert molding. The surface member may not be connected with the body.

The surface member preferably covers substantially the whole area of the impact receiving surface of the body. Substantially the whole area of the surface of the body 11 maybe covered by one piece of the surface member or a plurality of small surface members. Each of the small surface members may be in circular form of 25 mm or more in diameter or a square form of 25 mm or more on a side. The minimum size is preferably 25 mm, or more.

The body and the surface member are suitably combined by selecting the properties of the rigid polyurethane foam forming the body and the size (thickness) of the body, and the material, the properties, and the size (thickness) of the surface member according to the purpose, thereby providing an impact absorbing member having desired excellent impact energy absorbing efficiency.

The impact absorbing member of the present invention can be used suitably as, but not limited to, a head protecting member which is installed to vehicle body or an interior trim such as a head liner and a garnish.

### EXAMPLE AND COMPARATIVE EXAMPLE

Hereinafter, the present invention will be described in detail with reference to Example and Comparative Example. The following examples are only for illustrative purpose so that the present invention is not limited by the example.

### Example 1

A body made of a rigid polyurethane foam having the following properties and size and a surface member made of polypropylene having the following properties and size were prepared and were united together by bonding the surface member to the body with pressure-sensitive adhesive, thereby producing an impact absorbing member of the present invention.

Body: a rigid polyurethane foam having a compressive stress at 50% relative deformation of 8 kgf/cm² and a density of 100 kg/m³

150 mm×80 mm X 30 mm in thickness

Surface member: a PP plate having a flexural modulus of 45 MPa

100 mm×100 mm×1 mm in thickness

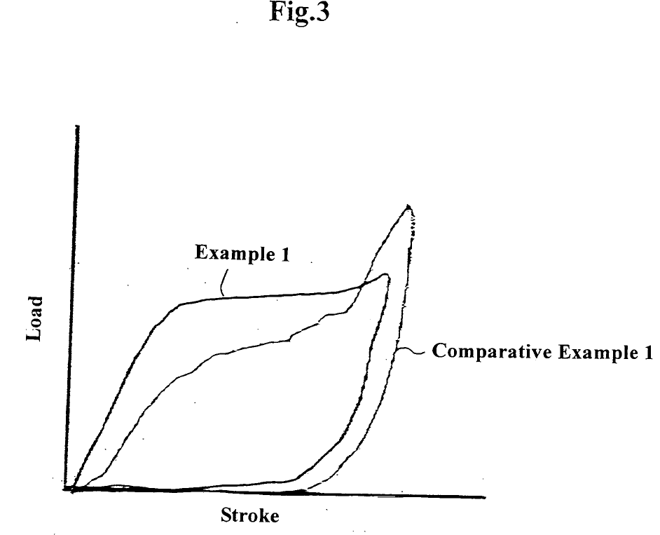

As for the impact absorbing member, an F-S waveform when an FMH collides with the center of the surface member at a speed of 6.7 m/sec was measured. The result of measurement is shown in FIG. 3.

The impact received by the dummy was measured as acceleration in a dynamic evaluation test using an FMH, and the value of head injury criteria (d) (HIC (d)) was calculated from the acceleration. As a result, the HIC value was 770. In general, an HIC (d) value of 1,000 or less is evaluated to be excellent in terms of impact energy absorbing efficiency. Automobile manufacturers develop products to have a value of 800 or less to increase certainty.

### Comparative Example 1

An impact absorbing member was composed of the same rigid polyurethane foam as for the body of Example 1 without the surface member of Example 1. The size of the impact absorbing member was 150 mm×80 mm×30 mm in thickness. Also as for this impact absorbing member, an F-S waveform was measured and the result is shown in FIG. 3. The value of the head injury criteria was 860.

It is clear from the above that the impact absorbing member of the present invention can exhibit significantly excellent impact energy absorbing efficiency.

As described in the above, the present invention can provide an impact absorbing member which has significantly excellent impact energy absorbing efficiency and is suitable as a head protecting member capable of absorbing impact energy applied to a head of an occupant in a vehicle cabin during a vehicle collision or the like and capable of reducing the value of head injury criteria.

What we claim is:

1. An impact absorbing member comprising: a body made of a rigid polyurethane foam; and a surface member which has a rigidity higher than that of the body and is disposed on one surface of the body.

2. An impact absorbing member as claimed in claim 1, wherein the body and the surface member are united together.

3. An impact absorbing member as claimed in claim 1 or 2, wherein the rigid polyurethane form has a compressive stress at 50% relative deformation of 0.25-2 MPa.

4. An impact absorbing member as claimed in any one of claims 1 through 3, wherein the rigid polyurethane form has a density of 40-200 kg/m³.

5. An impact absorbing member as claimed in any one of claims 1 through 4, wherein the surface member has a flexural modulus of 2-1500 MPa.

6. An impact absorbing member as claimed in any one of claims 1 through 5, wherein the surface member is a plate member disposed to cover substantially the whole area of the impact receiving surface of the body.

7. An impact absorbing member as claimed in any one of claims 1 through 6, wherein the thickness of the surface member is 0.5-5 mm.

8. An impact absorbing member as claimed in any one of claims 1 through 7, wherein the thickness of the body is 10-80 mm.

9. An impact absorbing member as claimed in any one of claims 1 through 8, wherein the impact absorbing member is used as a head protecting member for a vehicle and is installed to a vehicle body or an interior trim such as a head liner and a garnish.

10. An impact absorbing member as claimed in any one of claims 1 through 9, wherein substantially the whole area of the surface of the body is covered by one piece of the surface member.

11. An impact absorbing member as claimed in any one of claims 1 through 9, wherein substantially the whole area of the surface of the body is covered by a plurality of small surface members.
